(19) United States
(12) Patent Application Publication
(10) Pub. No.: US 2024/0165967 A1
(43) Pub. Date: May 23, 2024

(54) METHOD OF CURING UV-CURABLE INKJET INK IN A PRINTING MACHINE

(71) Applicant: Heidelberger Druckmaschinen AG, Heidelberg (DE)

(72) Inventors: Matthias Schlörholz, Plankstadt (DE); Michael Kohlmann, Frankenthal (DE)

(21) Appl. No.: 18/515,579

(22) Filed: Nov. 21, 2023

(30) Foreign Application Priority Data
Nov. 21, 2022 (EP) 22208481.6

(51) Int. Cl. B41J 11/00; B41J 2/45

(52) U.S. Cl. CPC B41J 11/00214; B41J 2/451

(57) ABSTRACT

A method of curing UV inkjet ink in a printing machine includes two curing steps. In a first step, the inkjet ink is irradiated at high radiation power for a short irradiation time to pin the ink. In a second step, the pinned UV inkjet ink is irradiated with UV radiation of lower radiation power for a longer irradiation time to finally cure the ink. The light sources are UV light-emitting diodes or flash lamps whose radiation powers are modified by optical focusing or different electrical actuation. The process results in cured printed products of high quality.

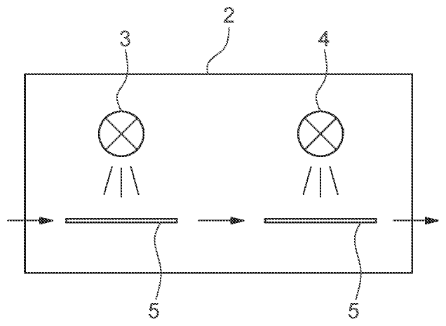

### CROSS-REFERENCE TO RELATED APPLICATION

This application claims the priority, under 35 U.S.C. § 119, of European Patent Application EP22208481.6, filed Nov. 21, 2022; the prior application is herewith incorporated by reference in its entirety.

### FIELD AND BACKGROUND OF THE INVENTION

The invention relates to a method of curing UV-curable inkjet ink in an inkjet printing machine.

Various printing processes using UV-curable printing media such as UV inkjet inks and UV varnishes are known in the printing industry. UV-curable inkjet inks that are to be cured by means of UV radiation in general comprise one or more UV photoinitiators. Once the print has been applied to the printing substrate such as paper, cardboard, or foil, the UV-curable inkjet inks need to be cured, which may also be referred to as dried. The result is a finished printed product which meets the requirements of commercial use and does not smear anymore.

Two-stage processes for curing UV-curable inkjet inks have become known in the art. These processes usually utilize mercury vapor lamps, the use of which is, however, becoming increasingly unpopular due to environmental concerns. In general, two-stage curing processes consist of a first partial curing step in which the UV-curable inkjet ink is only pre-cured, i.e., partially cured, and not cured through and through. This partial curing is also referred to as pinning. It is not until the end of the printing process in the inkjet printing machine that the pre-cured printed product is finally cured, usually by irradiation with UV radiation of high intensity. The use of UV light-emitting diodes (UV LEDs) or gas discharge lamps as radiation sources for curing UV-curable inkjet inks in printing machines is also generally known in the art.

European published patent application EP 3 718 777 A1, which is commonly assigned, discloses a device for curing UV ink on a printing substrate including UV LED radiation sources whose radiation angle is limited to reduce or avoid undesired matting effects on the printing substrate.

For some applications, however, the prior art processes of curing UV-curable inkjet inks in inkjet printing machines are not satisfactory. For instance, high printing speeds, which mean high printing substrate throughput, require particularly short curing times, which require complex technology or cannot be achieved at all using conventional curing processes. For low-migration inkjet inks in particular, which are highly reactive and cure very quickly, the prior art curing processes require complex equipment. Satisfactory curing of low-migration inkjet inks by means of UV light-emitting diodes has not been described so far.

### SUMMARY OF THE INVENTION

It is accordingly an object of the invention to provide a method of curing ink in an inkjet printing machine which overcomes a variety of disadvantages of the heretofore-known devices and methods of this general type and which provides for an improved process.

With the above and other objects in view there is provided, in accordance with the invention, a method of curing UV-curable inkjet ink in an inkjet printing machine, the method comprising:
in a first step, irradiating the UV-curable inkjet ink with UV radiation from a first light source to pin the inkjet ink to form pinned inkjet ink, thereby subjecting the inkjet ink to UV radiation of a radiation power S1 for an irradiation time t1 in the first step;
in a second step, irradiating the pinned UV-curable inkjet ink with UV radiation from a second light source to finally cure the inkjet ink, thereby subjecting the pinned inkjet ink to UV radiation of a radiation power S2 for an irradiation time t2 in the second step;
setting the radiation power S1 greater than the radiation power S2 and setting the radiation time t1 shorter than the irradiation time t2;
providing the first light source and the second light source as devices of identical design and selected from the group consisting of one or more flash lamps and one or more UV light-emitting diodes; and
when the light sources are flash lamps, setting the radiation powers S1 and S2 by electrically actuating the flash lamps of the first light source in a different way than the flash lamps of the second light source; and
when the light sources are UV light-emitting diodes, setting the radiation powers S1 and S2 by optically focusing the radiation of the UV light-emitting diodes of the first light source in a different way than the UV light-emitting diodes of the second light source.

Surprisingly, it has been found that a particularly simple and effective way of curing UV-curable inkjet inks in two-stage curing processes, including pinning and final curing, is possible if UV light-emitting diodes or flash lamps are used both for pinning and curing and if the radiation emitted by the UV light-emitting diodes or flash lamps is more focused in the pinning step than in the final curing step in the case of UV light-emitting diodes and if the emitted radiation is set to be stronger in the pinning step than in the final curing step due to different electrical actuation in the case of flash lamps, and if the irradiation times for the pinning step are selected to be shorter than in the final curing step. According to the invention, therefore, in the pinning step, the applied irradiation power is greater and the irradiation time is shorter whereas in the final curing step, irradiation power is lower and the irradiation time is longer. The results are surprising because, based on experiences with mercury vapor lamps, one would assume that it was better to apply a greater focus of the UV radiation and the resultant greater irradiation power of the UV irradiation in the final curing step than in the pinning step. However, it has been found that the application of the high radiation power for a longer time in the first step, i.e., in the pinning step, as opposed to the second, i.e., the final curing step, in general causes damage to the UV-curable inkjet ink and to the printing substrate.

The method of the invention provides a way to quickly and completely cure UV-curable inkjet ink on the printing substrate in the printing machine. Depending on the embodiment, conventional UV light-emitting diodes or flash lamps such as gas discharge lamps, which do not require much space in the machine, may be used as the radiation sources. UV light-emitting diodes and gas discharge lamps are comparatively cheap and generate only little waste heat and thus do not require sophisticated cooling measures to remove the heat. Moreover, the use of mercury vapor lamps, which is becoming increasingly unpopular for environmental reasons, in the printing machine may be avoided. As a result of the method of the invention, cured printed products of high quality may be produced.

Due to the use of flash lamps of identical design or of UV light-emitting diodes of identical design, which only require different electrical actuation or different optical focusing, ensure comparatively easy exchangeability, reparability, and controllability inside the inkjet printing machine. In principle, no different control units need to be installed for the flash lamps, a fact which saves space and service operations. Analogously, the same is true when UV light-emitting diodes of identical design are used.

Once more in summary, the present invention relates to a method of curing UV-curable inkjet ink in an inkjet printing machine, the method including a first step of irradiating the UV-curable inkjet ink with UV radiation from a first light source to pin it and a second step of irradiating the pinned UV-curable inkjet ink with UV radiation from a second light source to finally cure it, wherein the UV-curable inkjet ink is subjected to UV radiation of a radiation power S1 for an irradiation time t1 in the first step and the pinned UV-curable inkjet ink is subjected to UV radiation of a radiation power S2 for an irradiation time t2 in the second step, wherein radiation power S1 is greater than radiation power S2 and radiation time t1 is shorter than irradiation time t2, wherein the first light source and the second light source are devices of identical design and selected from a list including one or more flash lamps and one or more UV light-emitting diodes and wherein if the light sources are flash lamps, radiation powers S1 and S2 are set by electrically actuating the flash lamps of the first light source in a different way than the flash lamps of the second light source, and wherein if the light sources are UV light-emitting diodes, radiation powers S1 and S2 are set by optically focusing the radiation of the UV light-emitting diodes of the first light source in a different way than the UV light-emitting diodes of the second light source.

In the pinning step, the reactive UV-curable ink is not cured completely. Yet in this state, further processing within the inkjet printing machine is possible without any disadvantages for the printed image in particular. In the final curing step the pinned UV-curable inkjet ink, which is still reactive, is subsequently cured essentially completely through so as to be no longer reactive, ensuring that once the products have exited the inkjet printing machine and are used for their intended commercial purpose, no disadvantageous effects such as smearing or rubbing off occur.

In a preferred embodiment, the first light source and the second light source are disposed to be spaced apart from one another in the inkjet printing machine. The first light source, namely at least one flash lamp or, in an alternative embodiment, at least one UV light-emitting diode, is thus located at a different place than the second light source, namely at least one flash lamp or, in the alternative embodiment, at least one UV light-emitting diode.

In accordance with the invention, the radiation power S1, which is applied to the UV-curable medium in the first, pinning step, is greater than the radiation power S2, which is applied to the pinned UV-curable inkjet ink in the second, final curing step. The radiation power describes the radiation that hits the printing substrate per unit area and is measured in Watts per square centimeter (W/cm²).

In a preferred embodiment, the radiation is pulsed, i.e., applied to the printing substrate in the form of short flashes of light. In a particularly preferred embodiment, the radiation time t1 is composed of one radiation pulse per unit area and the radiation time t2 is composed of multiple radiation pulses per unit area. In a very particularly preferred embodiment, the radiation time t1 is composed of one radiation pulse per unit area and the radiation time t2 is composed of 2 to 10 radiation pulses per area unit, preferably of 2 to 5 radiation pulses per unit area. In this context, what is meant as the unit area it is always the same area on the printing substrate, which is only pinned in a first step and subsequently cured through.

In a further preferred embodiment, the radiation time t1 per unit area is composed of a radiation pulse of a time of between 0.05 and 0.7 milliseconds, preferably 0.1 and 0.5 milliseconds, and the radiation time t2 per unit area is composed of multiple radiation pulses of a time of between 0.8 and 5 milliseconds per radiation pulse per unit area, preferably of 1 to 3 milliseconds per radiation pulse.

In a further preferred embodiment, the radiation power S1 per radiation pulse is between 5 and 30 Watts per square centimeter, preferably between 10 and 25 Watts per square centimeter, and the radiation power S2 per radiation pulse is between 0.5 and 15 Watts per square centimeter, preferably between 0.8 and 12 Watts per square centimeter. When the radiation powers are selected, one needs to bear in mind that in accordance with the invention, S1 always needs to be greater than S2.

In a preferred embodiment, the radiation times t1 and t2 are set by at least one measure selected from a list including switching on the first light source and/or the second light source for different lengths of time, screening off the radiation of the first light source and/or of the second light source for different lengths of time, and combinations thereof.

In one embodiment of the invention, the first light source and the second light source are selected from a list including at least one flash lamp, preferably gas discharge lamps, especially xenon gas discharge lamps. Flash lamps are generally known in the art. In accordance with the invention, they are preferably gas discharge lamps, in particular xenon gas discharge lamps. An advantage of flash lamps such as xenon gas discharge lamps is that the parameters of the invention of the different radiation powers and radiation times may be set in a particularly easy way by suitably selecting electrode voltage, current power, and discharge time. In accordance with the invention, the embodiment with flash lamps utilizes flash lamps of identical design as the first and second light sources. Accordingly, they react in the same way when they are actuated in the same way.

In a preferred embodiment the first light source and the second light source are each selected from one or more flash lamps, and the different electrical actuation of the flash lamps is attained by a measure selected from applying different currents, applying different electrical voltages, and combinations thereof.

In a further embodiment of the invention, the first light source and the second light source are selected from at least one UV light-emitting diode whose radiation is optically focused in different ways. Thus the emitted UV radiation of the light-emitting diode may be applied to the printing substrate in a focused way. In this context, “focusing” the radiation means that the light rays are concentrated to ensure that the power that hits the printing substrate per unit area, in other words the radiation power, is increased compared to non-focused light rays. UV light-emitting diodes, which may also be referred to as UV LEDs, are generally known in the art. Such light-emitting diodes emit a particularly high proportion of UV radiation. They are commercially available from Seoul Semiconductor Co., Ltd., based in Ansan, South Korea.

In a preferred embodiment, the first light source and the second light source are selected a list including one or more UV light-emitting diodes, and the radiation of the first light source and the radiation of the second light source are each focused by means of one or more optical lenses. In this preferred embodiment, the radiation power of the UV radiation is lower in the second step, i.e., in the final curing step, than in the first step, i.e., the pinning step, despite the focusing.

In a further preferred embodiment, the first light source and the second light source are selected from a list including one or more UV light-emitting diodes, and the radiation of the first light source is focused by means of one or more optical lens(es) and the radiation of the second light source is not focused.

In a further preferred embodiment utilizing UV light-emitting diodes, the wavelength spectrum of the at least one light-emitting diode in the first step, namely the pinning step, is essentially identical with the wavelength spectrum of the at least one UV light-emitting diode in the second step, namely the final curing step. In accordance with the invention, the embodiment that utilizes UV light-emitting diodes uses UV light-emitting diodes of identical design are used in the first and second steps. When actuated in an identical way, these UV light-emitting diodes of identical design react in an identical way.

The method of the invention cures UV-curable inkjet inks. The UV-curable inkjet ink may in general be any UV inkjet ink that is usable in inkjet printing machines. UV-curable inkjet inks are generally known in the art and usually comprise one or more UV photoinitiators which may be converted to a reactive state by irradiation with UV light to initiate the curing reaction, mostly via a radical reaction mechanism. Accordingly, in a preferred embodiment, the UV-curable inkjet ink that is cured in the method of the invention comprises one or more UV photoinitiators.

The method of the invention is implemented in an inkjet printing machine. In a preferred embodiment, the inkjet printing machine comprises at least one inkjet printing head for applying the UV-curable ink.

In a preferred embodiment, the UV-curable inkjet ink is located on a printing substrate preferably selected from a list including paper, cardboard, and foil. In this context, the UV-curable inkjet ink has preferably been printed onto one of the afore-mentioned printing substrates by way of one or more inkjet printing heads.

In general, the method of the invention does not need to be carried out in the presence of an inert gas such as nitrogen or a noble gas, although it is possible. If curing takes place in the presence of an inert gas, it is preferably only the second step of final curing that is carried out in the presence of the inert gas.

Other features which are considered as characteristic for the invention are set forth in the appended claims.

Although the invention is illustrated and described herein as embodied in a method of curing UV-curable inkjet ink in a printing machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE of the drawing is a highly schematic illustration of an inkjet printing machine with two curing stages.

### DETAILED DESCRIPTION OF THE INVENTION

Referring now to the FIGURE of the drawing in detail, there is shown a schematic representation of a preferred exemplary embodiment of the method of the invention. In an inkjet printing machine (2), the UV inkjet ink is applied to a printing substrate (5), such as a sheet of paper, which is processed from left to right in the drawing FIGURE. The UV inkjet ink is pinned by means of a UV light-emitting diode, which forms a first light source (3). Subsequently, the printing substrate (5) that has received the print and bears the pinned UV inkjet ink is moved forwards through the inkjet printing machine (2) and may receive prints in different colors. Finally, the substrate is conveyed to a UV light-emitting diode, which forms a second light source (4). There, the ink is subjected to the final curing step. Once the final curing is completed, the finished printed product is guided out of the inkjet printing machine (2).

The following is a summary list of reference numerals and the corresponding structure used in the above description of the invention:
2 inkjet printing machine
3 first light source
4 second light source
5 printing substrate

1. A method of curing UV-curable inkjet ink in an inkjet printing machine, the method comprising:
in a first step, irradiating the UV-curable inkjet ink with UV radiation from a first light source to pin the inkjet ink to form pinned inkjet ink, thereby subjecting the inkjet ink to UV radiation of a radiation power S1 for an irradiation time t1 in the first step;
in a second step, irradiating the pinned UV-curable inkjet ink with UV radiation from a second light source to finally cure the inkjet ink, thereby subjecting the pinned inkjet ink to UV radiation of a radiation power S2 for an irradiation time t2 in the second step;
setting the radiation power S1 greater than the radiation power S2 and setting the radiation time t1 shorter than the irradiation time t2;
providing the first light source and the second light source as devices of identical design and selected from the group consisting of one or more flash lamps and one or more UV light-emitting diodes; and
when the light sources are flash lamps, setting the radiation powers S1 and S2 by electrically actuating the flash lamps of the first light source in a different way than the flash lamps of the second light source; and
when the light sources are UV light-emitting diodes, setting the radiation powers S1 and S2 by optically focusing the radiation of the UV light-emitting diodes of the first light source in a different way than the UV light-emitting diodes of the second light source.

2. The method according to claim 1, wherein radiation powers S1 and S2 are defined in Watts per square centimeter.

3. The method according to claim 1, which comprises placing the first light source and the second light source spatially separate from one another in the inkjet printing machine.

4. The method according to claim 1, wherein the irradiation time t1 is defined by one irradiation pulse per unit area and the irradiation time t2 is defined by multiple irradiation pulses per unit area.

5. The method according to claim 4, wherein the radiation time t1 is composed of one radiation pulse per unit area and the radiation time t2 is composed of 2 to 5 radiation pulses per unit area.

6. The method according to claim 4, wherein the radiation time t1 is composed of a radiation pulse of a duration of between 0.1 and 0.5 milliseconds per unit area and the radiation time t2 is composed of multiple radiation pulses of durations between 1 and 3 milliseconds per radiation pulse per unit area.

7. The method according to claim 4, which comprises setting the radiation power S1 to between 10 and 25 Watts per square centimeter per radiation pulse and setting the radiation power S2 to between 0.5 and 15 Watts per square centimeter per radiation pulse.

8. The method according to claim 1, which comprises setting the radiation times t1 and t2 by means of at least one measure selected from the group of measures consisting of switching on at least one of the first light source or the second light source for periods of different lengths, screening off the radiation of at least one of the first light source or the second light source for periods of different lengths, and combinations thereof.

9. The method according to claim 1, wherein the first light source and the second light source are one or more flash lamps and electrically actuating the flash lamps differently by applying different currents, different electrical voltages, or combinations thereof.

10. The method according to claim 1, wherein the first light source and the second light source are gas discharge lamps.

11. The method according to claim 10, wherein the gas discharge lamps are xenon gas discharge lamps.

12. The method according to claim 1, wherein the first light source and the second light source are one or more UV light-emitting diodes and the method comprises focusing a radiation of the first light source and a radiation of the second light source by way of one or more optical lenses.

13. The method according to claim 1, wherein the first light source and the second light source are one or more UV light-emitting diodes and the method comprises focusing a radiation of the first light source by one or more optical lenses and not focusing a radiation of the second light source.

14. The method according to claim 1, wherein the UV-curable inkjet ink comprises one or more UV photoinitiators.

15. The method according to claim 1, wherein the UV-curable inkjet ink is disposed on a printing substrate selected from the group consisting of paper, cardboard, and foil.
